(19) United States
(12) Patent Application Publication
(10) Pub. No.: US 2009/0075095 A1
(43) Pub. Date: Mar. 19, 2009

(54) METHODS FOR PROCESSING A SUBSTRATE HAVING A BACKSIDE LAYER

(76) Inventors: Igor Ivanov, San Jose, CA (US); Tony Chiang, Campbell, CA (US); Chi-I Lang, Sunnyvale, CA (US)

Correspondence Address: KALI LAW GROUP, P.C., P.O. BOX 60187, SUNNYVALE, CA, 94088-0167, US

(21) Appl. No.: 12/208,865

(22) Filed: Sep. 11, 2008

Related U.S. Application Data
(60) Provisional application No. 60/972,067, filed on Sep. 13, 2007.

(51) Int. Cl. B32B 27/30; B32B 9/00; B44C 1/22; B05D 1/18; C25D 5/02

(52) U.S. Cl. 428/446; 428/500; 216/83; 427/443.1; 216/53; 205/118

(57) ABSTRACT

Methods for processing a substrate utilizing a backside layer are presented including: receiving a substrate, the substrate including a front side and a backside; forming the backside layer on the backside of the substrate; and performing at least one processing operation on the front side of the substrate, wherein the backside layer protects the backside of the substrate during the performing the at least one processing operation. In some embodiments, methods further include cross-linking the backside layer such that the backside layer is stabilized. In some embodiments, methods further include: functionalizing the backside layer, where the functionalizing alters a chemical characteristic of the backside layer, and where the functionalizing includes a functional group such as: a hydroxyl group, an amino group, a mercapto group, a fluorine group, a chlorine group, an alkene group, an aryle group, and a carboxy group.

### PRIORITY CLAIM TO PROVISIONAL APPLICATION

A claim for priority is hereby made under the provisions of 35 U.S.C. § 119 for the present application based upon U.S. Provisional Application No. 60/972,067, filed on Sep. 19, 2007, which is incorporated herein by reference.

### CROSS REFERENCE TO RELATED APPLICATIONS

The present invention is related to the following applications, all of which are incorporated herein by reference:

Commonly assigned application entitled “SUBSTRATE PROCESSING INCLUDING A MASKING LAYER,” filed on Dec. 29, 2006 by the same inventors herein (Attorney Docket Number IMOL-00900/IM0015).

### BACKGROUND

During the manufacture of a semiconductor device, substrate surfaces (including front side, backside, and wafer edge/bevel) are often contaminated by various substances including, metals, particles, and organics. Contamination may arise from any number of point sources. For example, local environments may include any number of environmental pollutants that may contaminate substrate surfaces before, during, and after substrate processing. Further, contamination from wafer transport may occur if tooling is not fully and properly cleaned. Still further, contamination from wafer processing by impure process chemistry or by unwanted side reactions where chemistries are poorly controlled or poorly understood may adversely affect device performance and reliability. If left unresolved, contamination may result in failure of an entire manufacturing run.

One way to control these contaminations is to address each point source in turn. Clean room procedures may be implemented to avoid local environmental contamination. Careful tool cleaning and decontamination procedures may be implemented to avoid transport contamination. Careful chemistry preparation and application procedures may avoid process contamination. However, although each of these methods may provide adequate contamination control, the methods may still fall short where a point source is not properly identified or recognized.

For example, a backside of a substrate is often neglected or forgotten when developing contamination control strategies. The backside of a substrate, of necessity, comes into direct contact with all tooling. If a backside surface is contaminated with undesirable substances, then those undesirable substances may transfer to immediate tooling and, in turn, to other substrates or tools in subsequent processes. Some contaminants that have proven difficult to remove are ferroelectric-related contamination, such as Pb, Zr, Ti, and electrode-related contamination, such as Ir), which may migrate or otherwise form on a backside surface. In those cases, a sacrificial layer, such as silicon nitride or silicon dioxide may be utilized to prevent contamination. However, those sacrificial layers may be equally difficult to remove. Additionally, contaminants adhered onto the backside of a substrate may diffuse through the substrate and affect devices on the front side of the substrate. Further, during a wet process, a backside surface may be inadvertently contaminated by reactants or by unwanted side reactions, which may be carried and passed to subsequent processes. Thus, unrecognized contamination may adversely contribute to device performance and reliability.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative cross-sectional representation of a substrate having a backside surface in accordance with embodiments of the present invention;

FIG. 2 is an illustrative flowchart of methods for processing a substrate having a backside layer in accordance with embodiments of the present invention;

FIG. 3 is an illustrative representation of surface reactions occurring while forming a backside layer in accordance with embodiments of the present invention; and

FIG. 4 is an illustrative representation of a tool configured to apply a solution for forming a backside layer in accordance with embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

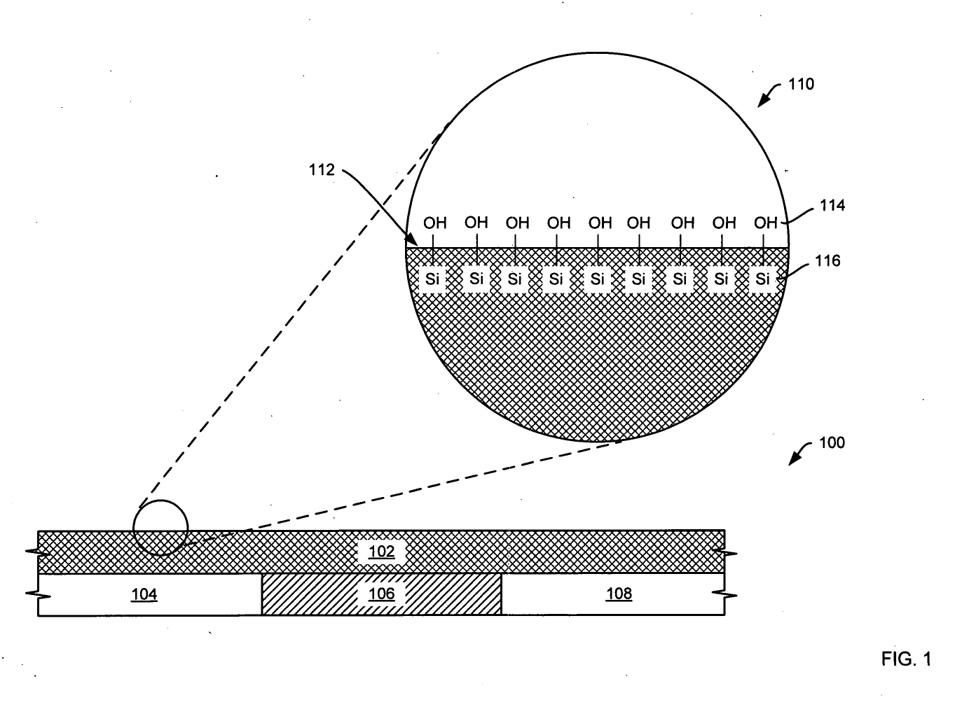

FIG. 1 is an illustrative cross-sectional representation of a substrate 100 having a backside surface 112 in accordance with embodiments of the present invention. As illustrated, substrate 100 may include base region 102 for supporting regions such as dielectric region 106 and conductive regions 104 and 108. In some embodiments, substrates may be a composition of any compound or substance well-known in the art without departing from the present invention including silicon and non-silicon substrates. In addition, substrates, as utilized in embodiments may have a hydrophobic surface, a hydrophilic surface, or some combination of hydrophobic surfaces and hydrophilic surfaces without limitation. Dielectric region 106 and conductive regions 104 and 108 may form or be part of semiconductor devices, metallization, or other structures formed on substrate 100. It may be appreciated that embodiments described herein may include any number of dielectric regions and conductive regions without departing from the present invention. Base regions may be composed of any suitable material well-known in the art without departing from the present invention (for example, substrate 100 may be a silicon wafer). In some embodiments, base regions include a hydrophilic surface. In some embodiments, base regions include a hydrophobic surface. As illustrated, backside surface 112 of exploded view 110 includes silicon dioxide (SiO₂). In an alternate embodiment the backside surface 112 may include another dielectric material such as TEOS (tetraethylorthosilicate). Backside surface 112 includes —OH molecules 114 attached with silicon molecules 116 which form a silicon matrix. —OH molecules 114 provide for a hydrophilic surface which may attract some aqueous processes. As such, backside surface 112 may be particularly vulnerable to aqueous processes.

In some embodiments, in order to protect backside surfaces from contamination and inadvertent reaction with process chemicals, a backside layer may be applied to backside surfaces. As utilized herein, the term backside layer refers to a backside self-assembled layer, which can be formed as a sub-layer, a mono-layer, or as a multilayer, and can be formed of organic material, inorganic material, or any combination of organic and inorganic material without departing from the present invention. Thus, utilizing embodiments provided herein, contaminants such as particles, metals, and organics may adhere to a protective backside layer instead of backside surfaces of substrates. In some embodiments, a backside layer may be functionalized to further prevent contaminants from adhering to backside surfaces.

In addition, embodiments may prevent a backside surface from inadvertent pitting or etching during wet processes. Pitting and etching backside surfaces may be especially pronounced when highly corrosive materials are utilized. Although the effects may not be immediately determinable, pitting and etching may, nevertheless, adversely affect device performance and reliability. Utilizing embodiments disclosed herein, backside layer embodiments may prevent unwanted side reactions from damaging or otherwise altering backside surfaces.

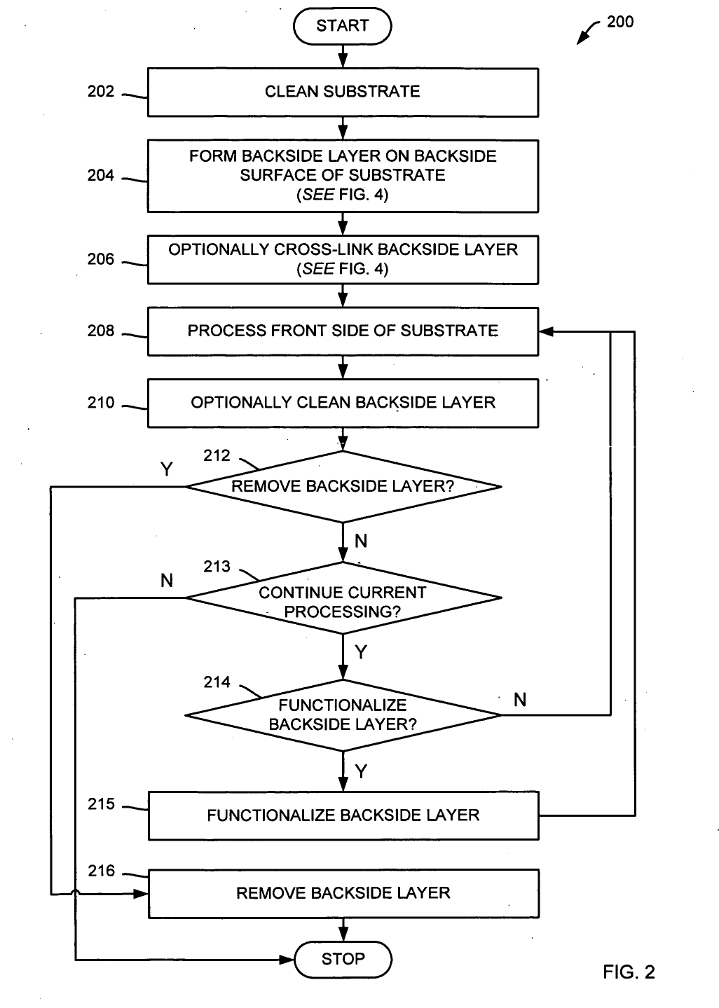

FIG. 2 is an illustrative flowchart 200 of methods for processing a substrate having a backside layer in accordance with embodiments of the present invention. It may be appreciated that the steps presented in embodiments described herein are not limited by order. Indeed, many process steps may be reordered or eliminated without departing from the present invention. At a first step 202, the method cleans a substrate. In particular, a backside surface of a substrate is cleaned. Cleaning may include any number of cleaning agents and cleaning steps without departing from the present invention including, a deionized water rinse, a solvent rinse, an acidic chemistry rinse, a basic chemistry rinses, a combination acid/base chemistry rinse, and any of a variety of other well-known surface cleaning steps to remove contaminants from previous processes. These cleaning steps may be delivered in any manner well-known in the art without departing from the present invention including, spray delivery, spin delivery, and immersion delivery.

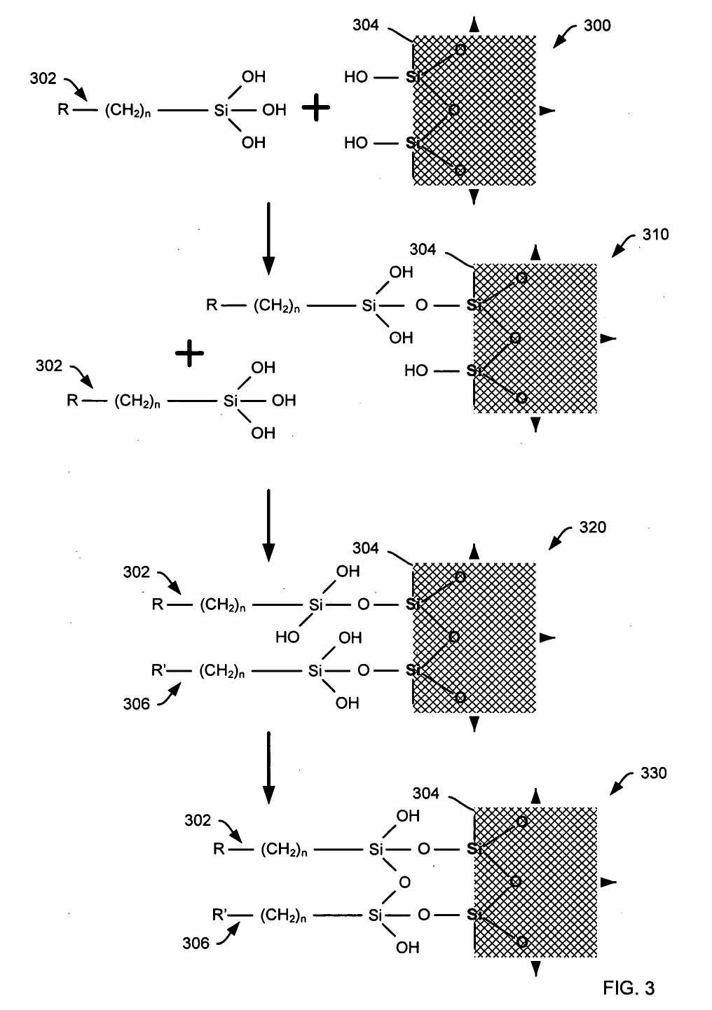

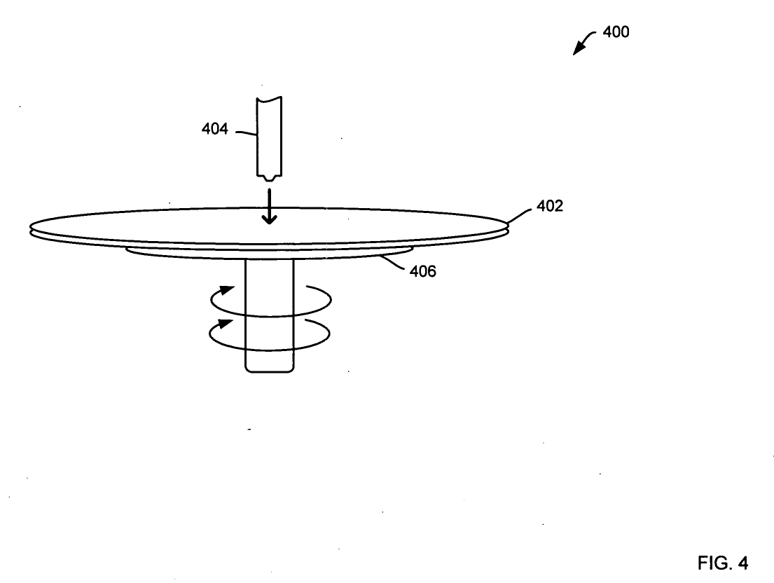

At a next step 204, a backside layer is formed on a backside surface. It may be appreciated that, in some embodiments, a layer having a substantially similar composition and formulation as the backside layer may be additionally formed on a front side surface, which layer may be formed simultaneously or sequentially with a backside layer. In addition, in some embodiments, it may be desirable to form a layer on edges and bevels of a substrate (e.g., a wafer) to more effectively protect a substrate from processes and contamination. Turning briefly to FIG. 4, an illustrative representation of a tool configured to apply a solution for forming a backside layer in accordance with embodiments of the present invention is illustrated. In particular, a spin processor 400 is illustrated which includes a base 406 for holding and spinning substrate 402. Reactants may be applied to backside surface of substrate 402 through applicator 404. It may be appreciated that any tool well-known in the art may be utilized for applying a backside layer including, a single wafer wet processing module, a bath, and a batch tool without departing from the present invention. Turning briefly to FIG. 3, FIG. 3 is an illustrative representation of surface reactions occurring while forming a backside layer in accordance with embodiments of the present invention. A backside surface 304 is illustrated having surface groups as described for FIG. 1. A backside layer precursor 302 may be applied to backside surface at a step 300. A first attached molecule is illustrated at a step 310. Additional molecules may attach with backside surface 304 as illustrated at a step 320. It may be appreciated that the illustrated example is not intended to show density of molecular attachment, but merely to provide reference for clarity in understanding embodiments described herein.

Backside layers may include compounds such as amines, alcohols, isolated silanols, vicinal silanols, and geminal silanols without departing from the present invention. In some embodiments, silanols are compounds having the formula: R—X—SiOH₃, where R is a hydrophobic group having a formula O(C₂H₄O)ₘCH₃, where m=an integer greater than zero; and X is an organic group having a formula (CH₂)ₙ, where n=an integer greater than zero. In some embodiments, R is a hydrophilic group. It may be appreciated that R groups may further include functional groups, which may be individually and selectively functionalized. Thus, in some embodiments, a functional group may be a hydroxyl group, an amino group, a mercapto group, a fluorine group, a chlorine group, an alkene group, an aryle group, and a carboxy group. Each of these groups, when functionalized, may impart a different chemical characteristic to a backside layer. In some examples, a backside layer includes a molecule having a branched and functionalized backbone. For example, functionalizing a hydroxyl group may impart hydrophilicity to a backside layer.

In another example, a backside layer can be functionalized to prevent contaminants from adhering to the backside layer itself. In some embodiments, a backside layer may include a composition having the formula Cₙ—Si—DMA, where n=4, 8, 12, and 18, which may exhibit protective characteristics when utilized in combination with various BOE concentrations and other aqueous processes. Thus, functionalizing groups may additionally be selected to prevent inadvertent side reactions. For example, a BOE or other fluorine-based solution may include highly corrosive materials. Appropriate functionalization may prevent highly corrosive materials from adversely affecting a backside surface by etching or pitting.

Returning to FIG. 2, at a next step 206a backside layer is optionally cross-linked. In some embodiments, it may be desirable to provide a more strongly linked backside layer to backside surfaces in order to protect backside surfaces from contamination and inadvertent reaction with process chemicals. For example, it may be desirable to make the backside layer resistant to high temperatures. Cross-linking describes forming a chemical bond between molecules of a backside layer. Turning briefly to FIG. 3, partial hydrolysis between steps 320 and 330 links the backbone of silane molecules of a backside molecule. Cross-linking may provide a more robust backside layer that is more resistive to subsequent processes. In some embodiments, a backside layer may be cross-linked by non-chemical modification utilizing deep ultraviolet (DUV) radiation, e-beam exposure, and atmospheric plasma. In some embodiments, cross-linking is accomplished at a temperature of approximately less than 100° Celsius (C) for a cross-linking period of less than 15 minutes, more preferably accomplished at a cross-linking temperature in the range of approximately 20 to 60° C. In some embodiments, a backside layer may be cross-linked by chemical modification. Chemical modification processes may be facilitated by creation of hydrophilic functional handles as provided by a backside layer. Cross-linking agents that may be utilized for chemical modification include: glutaraldehyde (or other dialdehyde), sulfuric acid (H₂SO₄), maleic acid, citric acid, and ascorbic acid without departing from the present invention. In some embodiments, the chemical modification cross-linking period is in the range of approximately 30 to 600 seconds.

Returning again to FIG. 2, at a next step 208, a substrate undergoes a process operation for processing a front side of a substrate. In some embodiments, a process operation includes an aqueous process. In some embodiments, aqueous processing includes a chemical mechanical planarization (CMP) cleaning process, a cleaning process, an electroplating process, an electroless (ELESS) deposition processes an electrochemical deposition process, a pre-CMP cleaning process, a post-CMP cleaning process, a via cleaning process, a contact cleaning process, a trench cleaning process, and a metallization process. In some embodiments, aqueous processing includes a BOE process utilizing a fluorine-based solution. The following experimental results are provided to illustrate advantages of embodiments utilizing various compositions of Cₙ—Si—DMA that are subjected to various BOE concentrations.

### Experimental Results I

The following tabulated experimental results demonstrate at least some advantages of embodiments of the present invention in combination with a buffered oxide etch (BOE). For embodiments in which a backside layer comprises Cₙ—Si—DMA, several specific examples of deposited Cₙ—Si—DMA layers are described herein. As used herein the term “deposited” and any derivation thereof broadly refers to the formation of a layer or region in any manner known in the art and may include all such manners without departing from the present invention. Such examples are provided for purposes of description only and represent unique instances of certain embodiments. Embodiments utilizing deposited Cₙ—Si—DMA layers exhibit protective characteristics when utilized in combination with various BOE concentrations. As may be appreciated, BOE processes are typically utilized to remove SiO₂. Thus, by processing a protected substrate utilizing a BOE process, a relative effectiveness may be determined that corresponds with a resulting change in thicknesses of the backside layer after BOE.

A first example of a deposited Cₙ—Si—DMA backside layer was formed on native oxide (SiO₂) by depositing two samples of a Cₙ—Si—DMA backside layer (denoted ‘n=4’, and ‘n=18’). A 10 mmol concentration of Cₙ—Si—DMA solution was deposited for 60 seconds (s) at approximately 25° C. followed by a 60 s deionized water rinse. A control, without a backside layer (denoted ‘No Protection’) was utilized for comparison. The samples and control were subjected to several BOEs having varying concentrations of HF (0.0%, 0.2%, 0.5%, 1.0%, and 5.0%). The samples and control were reacted for 30 s, at approximately 25° C. followed by a 60 s aqueous wash and a 60 s deionized water rinse. The change in thickness in Angstroms of the layers or the bare substrate was measured using ellipsometry techniques.

Native Oxide (SiO₂)

TABLE 1

| | Concentration | | | | |
|---|---|---|---|---|---|
| | 0.0% BOE | 0.2% BOE | 0.5% BOE | 1.0% BOE | 5.0% BOE |
| No | −1.7 | −2.5 | −3.9 | −11.5 | −15.0 |
| Protection | | | | | |
| n = 4 | 0.1 | −0.2 | 0.8 | −0.2 | −13.0 |
| n = 18 | 3.2 | 7.3 | 4.1 | 4.9 | −10.4 |

The results demonstrate that protective backside layer embodiments may provide significant substrate protection during BOE processes having HF concentrations up to approximately 1.0%.

A second example of a deposited Cₙ—Si—DMA backside layer was formed on tetraethyl orthosilicate (TEOS) by depositing two samples of a Cₙ—Si—DMA backside layer (denoted ‘n=4’, and ‘n=18’). A 10 mmol concentration of Cₙ—Si—DMA solution was deposited for 60 s at approximately 25° C. followed by a 60 s deionized water rinse. A control (denoted ‘No Protection’) was utilized for comparison. The samples and control were subjected to several BOEs having varying concentrations of HF (0.0%, 0.2%, 0.5%, 1.0%, and 5.0%). The samples and control were reacted for 30 s, at approximately 25° C. followed by a 60 s aqueous wash and a 60 s deionized water rinse. The thickness of the layers in Angstroms was measured using ellipsometry techniques.

TEOS

TABLE 2

| | Concentration | | | | |
|---|---|---|---|---|---|
| | 0.0% BOE | 0.2% BOE | 0.5% BOE | 1.0% BOE | 5.0% BOE |
| No | −2.9 | −4.8 | −34.5 | −125.1 | −145.3 |
| Protection | | | | | |
| n = 4 | 3.2 | 4.3 | 2.4 | −4.2 | −143.7 |
| n = 18 | 7 | 11.6 | 6.9 | −20.8 | −126.0 |

As above, the results demonstrate that protective embodiment layer embodiments may provide significant substrate protection during BOE processes having HF concentrations up to approximately 1.0%.

### Experimental Results II

The following tabulated experimental results demonstrate at least some advantages of embodiments of the present invention for preventing adsorption of contaminants on a substrate having a backside layer. For embodiments in which a backside layer comprises Cₙ—Si—DMA, several specific examples of deposited C₁₈—Si—DMA layers are described herein. As used herein the term “deposited” and any derivation thereof broadly refers to the formation of a layer or region in any manner known in the art and may include all such manners without departing from the present invention. Such examples are provided for purposes of description only and represent unique instances of certain embodiments. Embodiments utilizing deposited Cₙ—Si—DMA layers exhibit protective characteristics when deposited on a substrate such as a TEOS wafer. By exposing an untreated substrate and a treated substrate to a contaminant a relative effectiveness of a backside layer may be determined.

As the tabulated results below illustrate, a first TEOS wafer (denoted Coupon 1) was exposed to a 1000 ppm solution of CuSO₄ for 30 seconds (s). The first TEOS wafer then underwent a spin-rinse-dry (SRD) for 60 s on a Laurell spin processor. A first surface concentration of Cu contamination was then determined. A second TEOS wafer (denoted Coupon 2) we treated with a 100 mmol solution containing C₁₈—Si—DMA for 60 s. The second TEOS wafer was then exposed to a 1000 ppm solution of CuSO₄ for 30 s. The second TEOS wafer then underwent an SRD for 60 s on a Laurell spin processor. A second surface concentration of Cu contamination was then determined. A third TEOS wafer (denoted Coupon 2) we treated with a 100 mmol solution containing C₁₈—Si—DMA for 90 s. The third TEOS wafer was then exposed to a 1000 ppm solution of CuSO₄ for 30 s. The third TEOS wafer then underwent an SRD for 60 s on a Laurell spin processor. A third surface concentration of Cu contamination was then determined.

TEOS

TABLE 3

| | | Cu Contamination |
|---|---|---|
| | | Conc. |
| Coupon | Experiment | (×10¹⁰ atoms/cm²) |
| 1 | CuSo₄ (1000 ppm, 30 s) → SRD | 270 |
| | (60 s, Laurell) | |
| 2 | C₁₈-Si-DMA (100 mmol, 60 s) → CuSo₄ | 140 |
| | (1000 ppm, 30 s) → SRD (60 s, Laurell) | |
| 3 | C₁₈-Si-DMA (100 mmol, 90 s) → CuSo₄ | 100 |
| | (1000 ppm, 30 s) → SRD (60 s, Laurell) | |

These experimental results demonstrate that treatment of a TEOS substrate with a backside layer composed of C₁₈—Si—DMA resulted in a lower concentration of contamination for Coupons 2 and 3 as compared with control Coupon 1.

In other embodiments, a backside layer is composed of polyvinyl alcohol (PVA). In some embodiments, a backside layer includes a hydrophobic self-assembled monolayer configured to prevent adsorption of contaminants on a backside surface. For example, hydrophobically functionalized backside layer can prevent aqueous processes from interacting with the backside layer or leaving contaminants.

At a next step 210, the method optionally cleans the backside layer after processing. Cleaning may include any number of cleaning agents and cleaning steps without departing from the present invention including, a deionized water rinse, a solvent rinse, an acidic chemistry rinse, a basic chemistry rinses, a combination acid/base chemistry rinse, and any of a variety of other well-known surface cleaning steps to remove contaminants from previous processes. These cleaning steps may be delivered in any manner well-known in the art without departing from the present invention including, spray delivery, spin delivery, and immersion delivery.

At a next step 212, the method determines whether to remove the backside layer. If the method determines at a step 212 to remove the backside layer, the method proceeds to remove the backside layer at a step 216 whereupon the method ends. Removal of a backside layer may be accomplished utilizing any method or manner well-known in the art without departing from the present invention. Backside layers may be removed using conventional alkaline aqueous cleaning solutions, plasma treatments, lift off processes, high frequency treatment, and such. Removing a backside layer may remove any contaminants that adhered to the backside layer during previous processing steps. If the method determines at a step 212 not to remove the backside layer, the method determines at a step 213, whether to continue processing a backside layer. It may be appreciated that additional processing may take place at a later time or on other equipment or tooling. In some embodiments, additional processing (e.g., processing of the front side, including solvent based and dry processes) may advantageously utilize a backside layer for continued protection from contamination. In those examples, a backside layer may be retained during processing then optionally retained or removed as desired. Thus, in some embodiments, a finished substrate may include a backside layer.

If the method determines at a step 213 not to continue processing a backside layer, the method ends. If the method determines at a step 213 to continue processing a backside layer, the method continues to a step 214 to determine whether to functionalize the backside layer. If the method determines at a step 214 to functionalize the backside layer, the method continues to a step 215 to functionalize the backside layer. As noted above, a backside layer may include a functional group, which may be individually and selectively functionalized. Thus, in some embodiments, a functional group may be a hydroxyl group, an amino group, a mercapto group, a fluorine group, a chlorine group, an alkene group, an aryle group, and a carboxy group. Each of these groups, when functionalized, may impart a different chemical characteristic to a backside layer. For example, functionalizing a hydroxyl group may impart hydrophilicity to a backside layer. Appropriately functionalizing groups may be selected to prevent inadvertent side reactions. The method then continues to a step 208 to process a substrate. If the method determines at a step 214 not to functionalize the backside layer, the method continues to a step 208 to undergo a process operation for processing a front side of a substrate.

While this invention has been described in terms of several embodiments, there are alterations, permutations, and equivalents, which fall within the scope of this invention. It should also be noted that there are many alternative ways of implementing the methods and apparatuses of the present invention. Furthermore, unless explicitly stated, any method embodiments described herein are not constrained to a particular order or sequence. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. A method for processing a substrate utilizing a backside layer, the method comprising:
receiving a substrate, the substrate including a front side and a backside;
forming the backside layer on the backside of the substrate; and
performing at least one processing operation on the front side of the substrate, wherein the backside layer protects the backside of the substrate during the performing the at least one processing operation.

2. The method of claim 1, wherein the at least one processing operation is selected from the group consisting of: a fluorine-based solution buffered oxide etch (BOE), and an aqueous process.

3. The method of claim 2, wherein the aqueous process is selected from the group consisting of: a chemical mechanical planarization (CMP) cleaning process, a cleaning process, an electroplating process, an electroless (ELESS) deposition process, an electrochemical deposition process, a pre-CMP cleaning process, a post-CMP cleaning process, a via cleaning process, a contact cleaning process, a trench cleaning process, and a metallization process.

4. The method of claim 1, further comprising cross-linking the backside layer such that the backside layer is stabilized.

5. The method of claim 4, wherein
the cross-linking the backside layer includes a non-chemical modification selected from the group consisting of: deep ultraviolet (DUV) radiation, e-beam exposure, and atmospheric plasma, and wherein
the cross linking occurs over a cross-linking period of less than approximately 15 minutes at a cross-linking temperature of approximately less than 100° C.

6. The method of claim 4, wherein
the cross-linking the backside layer includes a chemical modification, wherein the chemical modification utilizes a cross-linking agent selected from the group consisting of: glutaraldehyde, dialdehydes, sulfuric acid (H₂SO₄), maleic acid, citric acid, and ascorbic acid, and wherein
the cross-linking occurs over a cross-linking period in a range of approximately 30 to 600 seconds.

7. The method of claim 5, further comprising cross-linking across functional groups of a backbone of a molecule of the layer.

8. The method of claim 1, further comprising forming a front side monolayer on the front side of the substrate, wherein the front side monolayer protects the front side of the substrate during the performing the at least one processing operation.

9. The method of claim 1, further comprising functionalizing the backside layer, wherein the functionalizing alters a chemical characteristic of the backside layer, and wherein the functionalizing includes a functional group selected from the group consisting of: a hydroxyl group, an amino group, a mercapto group, a fluorine group, a chlorine group, an alkene group, an aryle group, and a carboxy group.

10. The method of claim 9, wherein the backside layer includes a molecule comprising a branched and functionalized backbone.

11. The method of claim 1, further comprising removing the backside layer.

12. The method of claim 1, wherein the backside layer includes a compound selected from the group consisting of: amines, alcohols, isolated silanols, vicinal silanols, and geminal silanols, wherein the silanols include compounds having the formula:
R—X—SiOH₃, wherein
R is a hydrophobic group having a formula O(C₂H₄O)ₘCH₃, wherein m=an integer greater than zero; and
X is an organic group having a formula (CH₂)ₙ, wherein n=an integer greater than zero.

13. The method of claim 1, wherein the backside layer includes a compound having the formula Cₙ—Si—DMA, wherein n is an integer selected from the group consisting of: 4, 8, 12, and 18.

14. The method of claim 1, wherein the backside layer comprises a hydrophobic self-assembled monolayer (SAM) to prevent adsorption of the contaminants.

15. A substrate comprising:
a front side to be processed using a subsequent process;
a backside; and
a removable backside layer for protecting the backside and for preventing contamination of the backside during the subsequent process.

16. The substrate of claim 15, wherein the removable backside layer is cross-linked.

17. The substrate of claim 15, wherein the removable backside layer comprises a silanol having the formula:
R—X—SiOH₃, wherein
R is a hydrophobic group having a formula O(C₂H₄O)ₘCH₃, where m=an integer greater than zero; and
X is an organic group having a formula (CH₂)ₙ, where n=an integer greater than zero.

18. The substrate of claim 15, wherein
the removable backside layer includes a compound having the formula:
Cₙ—Si—DMA, wherein n is an integer selected from the group consisting of: 4, 8, 12, and 18, and wherein
the backside of the substrate is a composition selected from the group consisting of: TEOS (tetraethylorthosilicate) and SiO₂.

19. The substrate of claim 15, wherein the removable backside layer comprises polyvinyl alcohol (PVA).

20. The substrate of claim 15, wherein the removable backside layer covers an edge and a bevel of the substrate.
